(19) United States
(12) Patent Application Publication
(10) Pub. No.: US 2006/0089940 A1
(43) Pub. Date: Apr. 27, 2006

(54) Instantaneous integrated system and method of heterogeneous databases

(75) Inventor: I-Ching Li, Shindian City (TW)

Correspondence Address: BIRCH STEWART KOLASCH & BIRCH, PO BOX 747, FALLS CHURCH, VA, 22040-0747, US

(73) Assignee: VIA Technologies, Inc.

(21) Appl. No.: 11/119,709

(22) Filed: May 3, 2005

(30) Foreign Application Priority Data
Oct. 26, 2004 (TW) 093132449

(51) Int. Cl. G06F 17/00

(52) U.S. Cl. 707/101

(57) ABSTRACT

An instantaneous integrated system of heterogeneous databases comprises at least one first-type database, a computing device, and a database exchanging platform. The computing device comprises a second-type database and a user interface from which a first instantaneous instruction is issued. The database exchanging platform establishes at least one first instruction according to the first instantaneous instruction and selects first data from the first-type database according to the first instruction. Then, the database exchanging platform translates the format of the first data to produce second data, which match the format of a second-type database. The database exchanging platform transmits the second data to the computing device.

### BACKGROUND OF THE INVENTION

1. Field of Invention

The invention relates to a data instantaneous integrated system and method and, in particular, to an instantaneous integrated system and method of heterogeneous databases.

2. Related Art

The big-scale enterprise usually has huge organization, complex technology resources and variant products. To properly manage the information of the enterprise (such as the personnel matters, manufacturing equipments, research, financial affairs and the likes), it is necessary to build a database for immediately and exactly managing the above-mentioned important information. However, the enterprise may have many branches distributed at different locations all over the world across the limitations of ocean and land. Different branches may have databases of different specifications. These factors will make the instantaneous integration of information in the entire enterprise non-smoothly, and thus the staff member must do some extra works to get and integrate the data from different branches.

As shown in FIG. 1A, a user can operate a client device 14 to retrieve desired data from a first database 11, a second database 12 and a third database 13. Since the number of data is very huge, the user may miss some data or get the wrong data. In addition, the user must switch between those databases 11, 12 and 13, so some errors may occur due to the distraction of the user. Besides, when the specific data are retrieved, it is necessary to manually check the data by the user so as to determine whether the data are correct or not. Above all, since the databases might be heterogeneous databases, the user must update the specific data to each of databases one by one after the check process.

Thus, no matter to retrieve, check or update the specific data, the user must link to each of the databases and then execute the necessary instruction(s). In this case, it is impossible to complete the retrieving, checking, and updating processes by only one single interface. Moreover, the complex operation processes may make the user have some mistakes, resulting in fail to get correct data, and the data updating process may incorrect due to the user's mistakes.

To overcome the previously mentioned problem caused by the database link operation, a master database 15 can be built, and a translating program is developed to download the data from other databases and then to save the download data in the master database 15. As shown in FIG. 1B, the data in the first database 11, the second database 12 and the third database 13 can be downloaded to a first database copy 151, a second database copy 152 and a third database copy 153 stored in the master database 15 via the translating program. The user can operate the client device 14 to create a connection with the master database 15, and then to execute database instructions so as to retrieve desired data from the first database copy 151, the second database copy 152 and the third database copy 153.

However, in the conventional art as mentioned above, if the master database 15 is unable to use the translating program to download the updating data from other databases immediately, it can not instantaneously represent the actual data in other databases. Thus, the user may retrieve some data from the master database 15, and the retrieved data are different from the current data shown in other databases. In addition, the data transmission speed between the databases is constrained by the network quality and the bandwidth of the network. Thus, when the network is unstable and the bandwidth is insufficient, the download procedure via the translating program may spend lot of time. Therefore, the data update becomes inefficient, and the data in the master database 15 might be not instantaneous and correct.

It is therefore an important subjective of the invention to provide instantaneous integrated system and method of heterogeneous databases, which can immediately link to other heterogeneous databases and integrate data from different databases according to the instantaneous instructions issued by a user. Thus, the data prepared for the user is instantaneous and correct.

### SUMMARY OF THE INVENTION

In view of the foregoing, the invention is to provide instantaneous integrated system and method of heterogeneous databases, which can immediately integrate data from heterogeneous databases.

To achieve the above, an instantaneous integrated system of heterogeneous databases of the invention includes at least one first-type database, a computing device and a database exchanging platform. The computing device includes a second-type database and a user interface. A first instantaneous instruction is issued from the user interface. The database exchanging platform establishes at least one first instruction according to the first instantaneous instruction, selects first data from the first-type database according to the first instruction, translates the format of the first data to produce second data, and transmits the second data to the computing device. Wherein, the second data match the format of the second-type database.

In addition, the invention discloses an instantaneous integrated method of heterogeneous databases, which is performed when a database exchanging platform receives a first instantaneous instruction issued from a user interface of a computing device. The instantaneous integrated method includes the steps of: establishing at least one first instruction by the database exchanging platform according to the first instantaneous instruction; selecting first data from at least one first-type database by the database exchanging platform according to the first instruction; translating the format of the first data to produce second data by the database exchanging platform, wherein the second data match the format of a second-type database; and transmitting the second data from the database exchanging platform to the computing device.

As mentioned above, the instantaneous integrated system and method of heterogeneous databases of the invention utilize the database exchanging platform to instantaneously link to each of the heterogeneous databases and to integrate data from each database according to the instantaneous instruction. Thus, the user can instantaneously and correctly retrieve the data of the heterogeneous databases.

### BRIEF DESCRIPTION OF THE DRAWINGS

The invention will become more fully understood from the detailed description given herein below illustration only, and thus is not limitative of the present invention, and wherein:

FIG. 1A is a schematic view showing the conventional manual method of operating several databases;

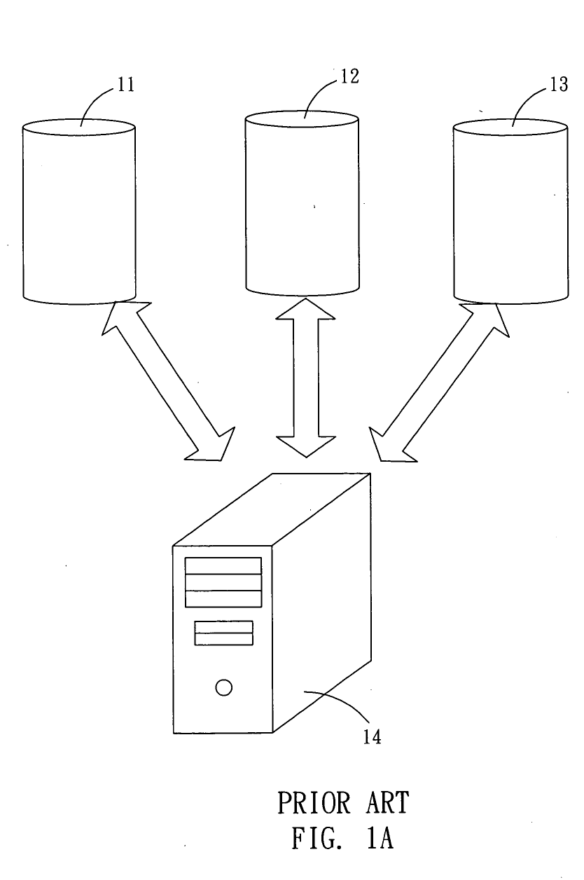

FIG. 1B is a schematic view showing the conventional master database for translating several databases;

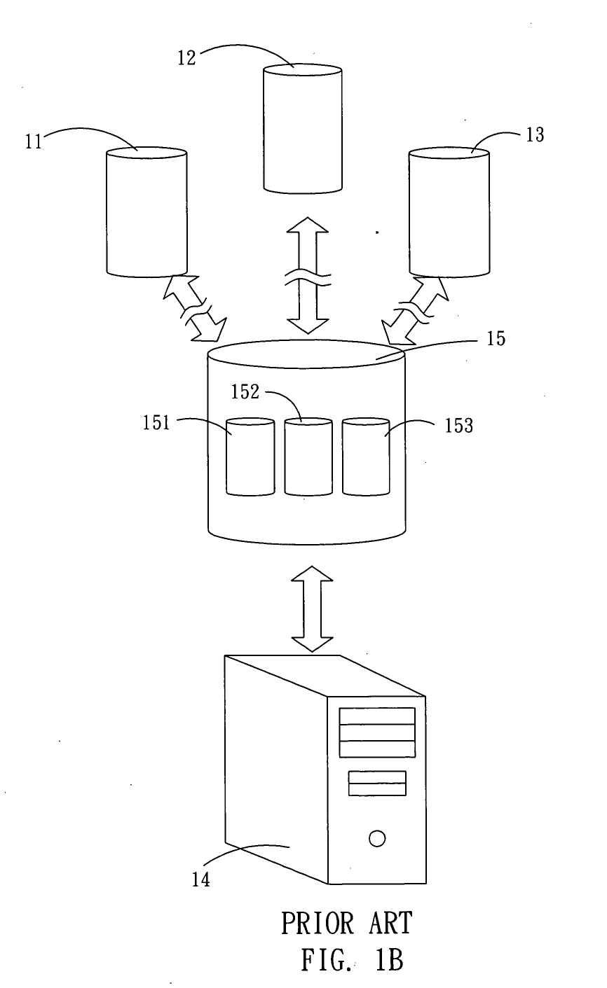

FIG. 2 is a schematic view showing an instantaneous integrated system of heterogeneous databases according to a preferred embodiment of the invention;

FIG. 3 is a schematic view showing the instantaneous integrated system of heterogeneous databases according to the embodiment of the invention, wherein the database exchanging platform further includes a data integration module;

FIG. 4 is a schematic view showing the instantaneous integrated system of heterogeneous databases according to the embodiment of the invention, wherein a window interface shows an integrated result of third data and fourth data;

FIG. 5 is a schematic view showing the instantaneous integrated system of heterogeneous databases according to the embodiment of the invention, wherein a window interface shows an analyze result;

FIG. 6 is a flow chart showing an instantaneous integrated method of heterogeneous databases according to a preferred embodiment of the invention;

FIG. 7 is a flow chart showing a data integrating step of the instantaneous integrated method of heterogeneous databases according to the embodiment of the invention; and

FIG. 8 is a flow chart showing a data analyzing step of the instantaneous integrated method of heterogeneous databases according to the embodiment of the invention.

### DETAILED DESCRIPTION OF THE INVENTION

The present invention will be apparent from the following detailed description, which proceeds with reference to the accompanying drawings, wherein the same references relate to the same elements.

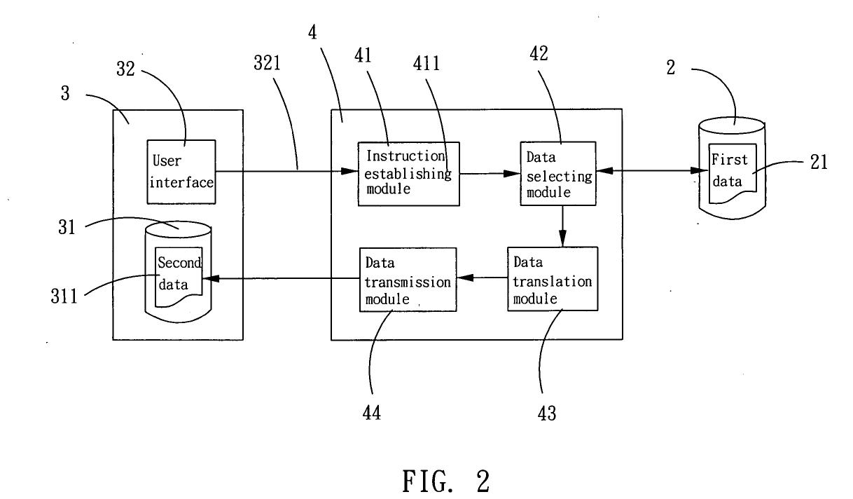

With reference to FIG. 2, an instantaneous integrated system of heterogeneous databases according to a preferred embodiment of the invention includes at least one first-type database 2, a computing device 3 and a database exchanging platform 4. The computing device 3 includes a second-type database 31 and a user interface 32 from which a first instantaneous instruction 321 is issued. The database exchanging platform 4 establishes at least one first instruction according to the first instantaneous instruction 321, selects first data 21 from the first-type database 2 according to the first instruction, translates the format of the first data 21 to produce second data 311, and transmits the second data 311 to the computing device 3. In this case, the second data 311 match the format of the second-type database 31.

In the present embodiment, the database exchanging platform 4 includes an instruction establishing module 41, a data selecting module 42, a data translation module 43, and a data transmission module 44. The instruction establishing module 41 establishes at least one first instruction 411 according to the first instantaneous instruction 321. The first instruction 411 matches the instruction format of the first-type database 2. The data selecting module 42 selects the first data 21 from the first-type database 2 according to the first instruction 411. The data translation module 43 translates the format of the first data 21 to produce the second data 311, which match the format of the second-type database 31. The data transmission module 44 transmits the second data 311 to the computing device 3.

In this embodiment, the first-type database 2, the computing device 3 and the database exchanging platform 4 are connected to one another with Internet. The first instantaneous instruction 321 can be an SQL instruction, and the user interface 32 can be a window (interface). The data selecting module 42 links to the first-type database 2 via a database access interface so as to build the connection between the database exchanging platform 4 and the first-type database 2. Thus, the data selecting module 42 can instantaneously get in the first-type database 2 and select the first data 21. This method is different from the conventional art as described previously that the data in the first-type database are downloaded in advance.

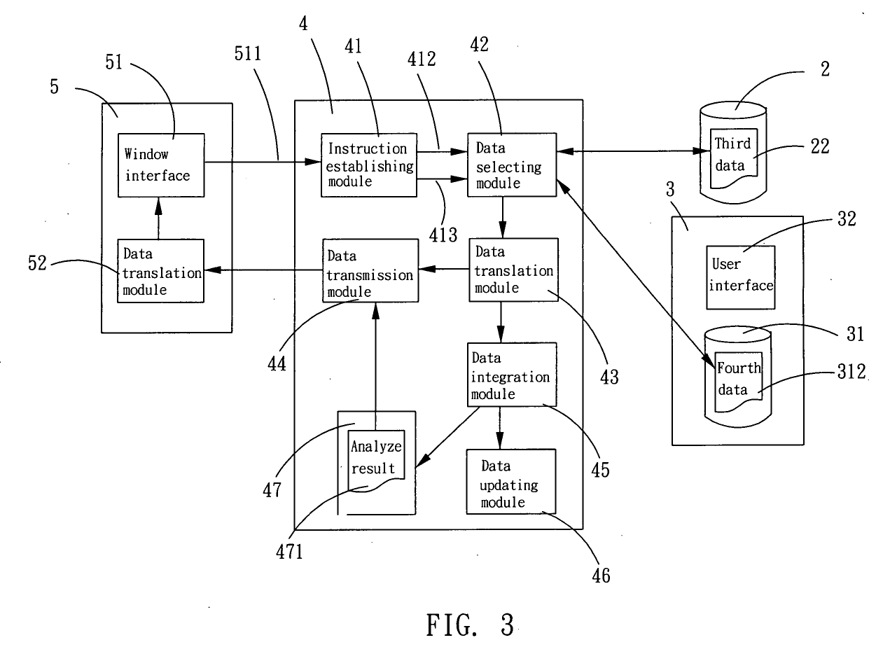

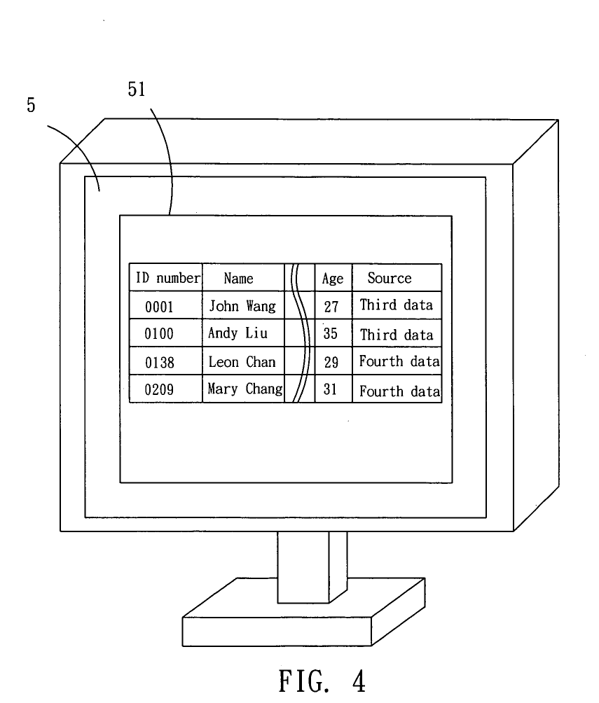

With reference to FIGS. 3 and 4, the database exchanging platform 4 further includes a data integration module 45 and a data updating module 46. A computing device 5 includes a data displaying module 52 and a window interface 51 for receiving a second instantaneous instruction 511. The instruction establishing module 41 establishes at least one second instruction 412 and a third instruction 413 according to the second instantaneous instruction 511. The second instruction 412 matches the instruction format of the first-type database 2, and the third instruction 413 matches the instruction format of the second-type database 31. The data selecting module 42 selects third data 22 from the first-type database 2 according to the second instruction 412, and selects fourth data 312 from the second-type database 31 according to the third instruction 413. The data integration module 45 integrates the third data 22 and the fourth data 312 to generate an integrated result. The data transmission module 44 then outputs the integrated result of the third data 22 and the fourth data 312 to the computing device 5. The data displaying module 52 displays the integrated result of the third data 22 and the fourth data 312 with the window interface 51.

The data updating module 46 determines which one of the third data 22 and the fourth 312 data are more correct (or latest). When the third data 22 are more correct (or latest), the data updating module 46 uses the third data 22 to update the fourth data 312. When the fourth data 312 are more correct (or latest), the data updating module 46 uses the fourth data 312 to update the third data 22. In the present embodiment, the data update method may be a merge method, which includes insert, delete and update.

In the current embodiment, the first-type database 2, the computing device 3, the database exchanging platform 4 and computing device 5 are connected to one another with Internet. The second instantaneous instruction 511 can be an SQL instruction. The data selecting module 42 links to the first-type database 2 and the second-type database 31 via a database access interface so as to build the connections between the database exchanging platform 4 and the first-type database 2 and between the database exchanging platform 4 and the second-type database 31. Thus, the data selecting module 42 can instantaneously get in the first-type database 2 to select the third data 22 and get in the second-type database 31 to select the fourth data 312. This method is different from the conventional art as described previously that the data in the first-type and second-type databases are downloaded in advance.

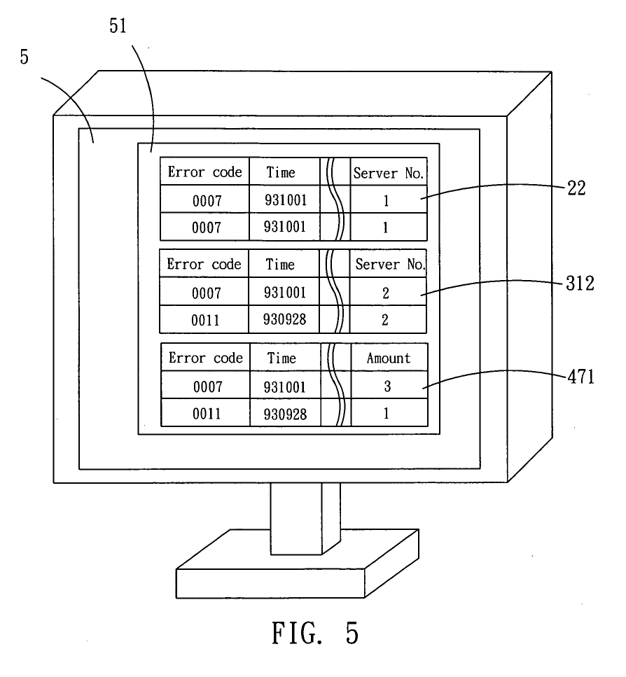

With reference to FIGS. 3 and 5, the database exchanging platform 4 further includes a data analyze module 47, which analyzes the integrated result of the third data 22 and the fourth data 312 to generate an analyze result 471. The data transmission module 44 outputs the analyze result 471 to the computing device 5, and the data displaying module 52 displays the analyze result 471 with the window interface 51. On the other hand, the data analyze module 47 may analyze the first data 21 to generate the analyze result 471, which is outputted to the computing device 3 by the data transmission module 44. In the embodiment, the integrated result of the third data 22 and the fourth data 312 includes the error log files of the first-type database 2 and second-type database 31. Thus, the data analyzing module 47 can analyze the reasons causing the error so as to count the numbers of vary kinds of errors and to record the counted numbers in the analyze result 471.

In addition, the data analyzing module 47 can generate an analyze result 471 according to the first data 21, and the data transmission module 44 outputs the analyze result 471 to the computing device 3.

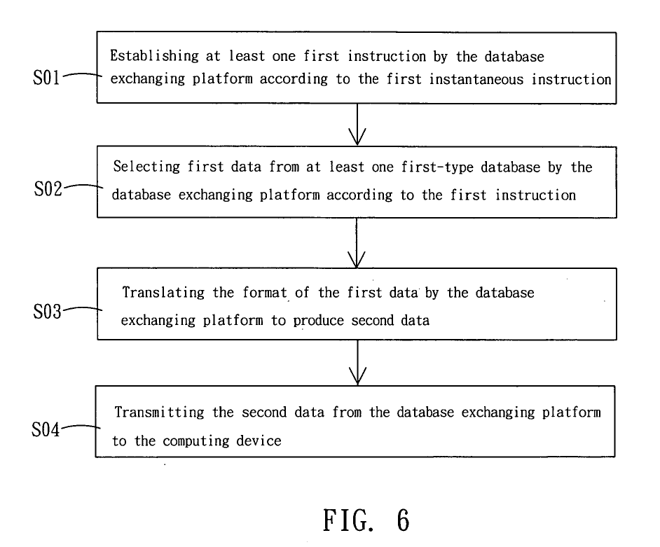

With reference to FIG. 6, an instantaneous integrated method of heterogeneous databases according to a preferred embodiment of the invention, which is performed when a database exchanging platform receives a first instantaneous instruction issued from a user interface of a computing device, includes the following steps S01 to S04.

In step S01, the database exchanging platform establishes at least one first instruction according to the first instantaneous instruction.

In step S02, the database exchanging platform selects first data from at least one first-type database according to the first instruction.

In step S03, the database exchanging platform translates the format of the first data to produce second data. Herein, the second data match the format of a second-type database.

In step S04, the second data are transmitted from the database exchanging platform to the computing device.

The detailed steps of the instantaneous integrated method of the embodiment are the same as illustrated in the previous embodiment with reference to FIG. 2, so the detailed descriptions are omitted for concise purpose.

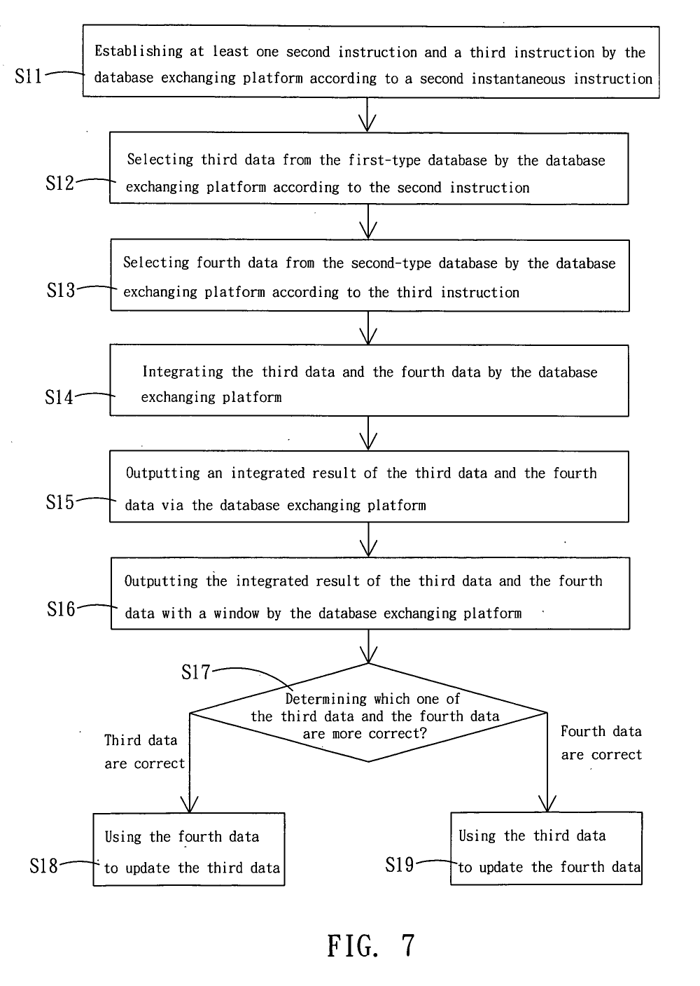

With reference to FIG. 7, the instantaneous integrated method of the embodiment may further include the following steps S11 to S19.

In step S11, the database exchanging platform establishes at least one second instruction and a third instruction according to a second instantaneous instruction.

In step S12, the database exchanging platform selects third data from the first-type database according to the second instruction.

In step S13, the database exchanging platform selects fourth data from the second-type database according to the third instruction.

In step S14, the database exchanging platform integrates the third data and the fourth data.

In step S15, an integrated result of the third data and the fourth data is outputted via the database exchanging platform.

In step S16, the database exchanging platform outputs the integrated result of the third data and the fourth data with a window.

In step S17, the database exchanging platform determines which one of the third data and the fourth data are more correct. When the third data are more correct, then the step S18 is performed; otherwise, when the fourth data are more correct, the step S19 is performed.

The step S18 is to use the fourth data to update the third data, and the step S19 is to use the third data to update the fourth data.

The detailed steps of the instantaneous integrated method of this embodiment are the same as illustrated in the previous embodiment with reference to FIGS. 3 and 4, so the detailed descriptions are omitted for concise purpose.

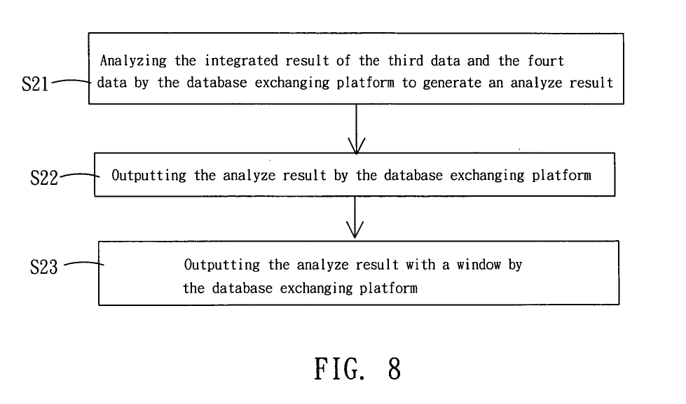

With reference to FIG. 8, the instantaneous integrated method of the embodiment may further include the following steps S21 to S23.

In step S21, the database exchanging platform analyzes the integrated result of the third data and the fourth data to generate an analyze result.

In step S22, the database exchanging platform outputs the analyze result.

In step S23, the database exchanging platform outputs the analyze result with a window.

The detailed steps of the instantaneous integrated method of this embodiment are the same as illustrated in the previous embodiment with reference to FIGS. 3 and 5, so the detailed descriptions are omitted for concise purpose.

In summary, the instantaneous integrated system and method of heterogeneous databases of the invention utilize the database exchanging platform to instantaneously link to each of the heterogeneous databases and to integrate data from each database according to the instantaneous instruction issued by the user. Thus, the user can instantaneously and correctly retrieve the data of the heterogeneous databases.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An instantaneous integrated method of heterogeneous databases, wherein when a database exchanging platform receives a first instantaneous instruction issued from a user interface of a computing device, the instantaneous integrated method is performed, the instantaneous integrated method comprising:
establishing at least one first instruction by the database exchanging platform according to the first instantaneous instruction;
selecting first data from at least one first-type database by the database exchanging platform according to the first instruction;
translating the format of the first data to produce second data by the database exchanging platform, wherein the second data match the format of a second-type database; and
transmitting the second data from the database exchanging platform to the computing device.

2. The instantaneous integrated method of claim 1, further comprising:
establishing at least one second instruction and a third instruction by the database exchanging platform according to a second instantaneous instruction;
selecting third data from the first-type database by the database exchanging platform according to the second instruction;
selecting fourth data from the second-type database by the database exchanging platform according to the third instruction;
integrating the third data and the fourth data by the database exchanging platform; and
outputting an integrated result of the third data and the fourth data via the database exchanging platform.

3. The instantaneous integrated method of claim 2, further comprising:
determining which one of the third data and the fourth data are correct by the database exchanging platform;
when the third data are correct, using the third data to update the fourth data; and
when the fourth data are correct, using the fourth data to update the third data.

4. The instantaneous integrated method of claim 2, wherein the database exchanging platform outputs the integrated result of the third data and the fourth data with a window.

5. The instantaneous integrated method of claim 2, further comprising:
analyzing the integrated result of the third data and the fourth data by the database exchanging platform to generate an analyze result; and
outputting the analyze result via the database exchanging platform.

6. The instantaneous integrated method of claim 5, wherein the database exchanging platform outputs the analyze result with a window.

7. The instantaneous integrated method of claim 1, further comprising:
analyzing the first data by the database exchanging platform to generate an analyze result; and
outputting the analyze result via the database exchanging platform.

8. The instantaneous integrated method of claim 7, wherein the database exchanging platform outputs the analyze result with a window.

9. The instantaneous integrated method of claim 1, wherein the computing device, the database exchanging platform, the first-type database and the second-type database are connected to one another with Internet.

10. An instantaneous integrated system of heterogeneous databases, comprising:
at least one first-type database;
a computing device, which comprises a second-type database and a user interface, wherein a first instantaneous instruction is issued from the user interface; and
a database exchanging platform, which establishes at least one first instruction according to the first instantaneous instruction, selects first data from the first-type database according to the first instruction, translates the format of the first data to produce second data, and transmits the second data to the computing device, wherein the second data match the format of the second-type database.

11. The instantaneous integrated system of claim 10, wherein the database exchanging platform further comprises:
an instruction establishing module, which establishes the first instruction according to the first instantaneous instruction;
a data selecting module, which selects the first data from the first-type database according to the first instruction;
a data translation module, which translates the format of the first data to produce the second data, wherein the second data match the format of the second-type database; and
a data transmission module, which transmits the second data to the computing device.

12. The instantaneous integrated system of claim 11, wherein the instruction establishing module further establishes at least one second instruction and a third instruction according to a second instantaneous instruction, and the data selecting module further selects third data from the first-type database according to the second instruction and selects fourth data from the second-type database according to the third instruction.

13. The instantaneous integrated system of claim 12, wherein the database exchanging platform further comprises:
a data updating module, which determines which one of the third data and the fourth data are correct, uses the third data to update the fourth data when the third data are correct, and uses the fourth data to update the third data when the fourth data are correct.

14. The instantaneous integrated system of claim 12, wherein the database exchanging platform further comprises:
a data integration module, which integrates the third data and the fourth data to generate an integrated result, wherein the integrated result of the third data and the fourth data is outputted via the data transmission module.

15. The instantaneous integrated system of claim 14, further comprising:
a data displaying module, which displays the integrated result of the third data and the fourth data with a window.

16. The instantaneous integrated system of claim 14, wherein the database exchanging platform further comprises:
a data analyze module, which analyzes the integrated result of the third data and the fourth data to generate an analyze result, wherein the analyze result is outputted via the data transmission module.

17. The instantaneous integrated system of claim 16, further comprising:
a data displaying module, which displays the analyze result with a window.

18. The instantaneous integrated system of claim 11, wherein the database exchanging platform further comprises:
a data analyze module, which analyzes the first data to generate an analyze result, wherein the analyze result is outputted via the data transmission module.

19. The instantaneous integrated system of claim 18, further comprising:
a data displaying module, which displays the analyze result with a window.

20. The instantaneous integrated system of claim 10, wherein the computing device, the database exchanging platform, the first-type database and the second-type database are connected to one another with Internet.
